(19) United States
(12) Patent Application Publication
(10) Pub. No.: US 2010/0041372 A1
(43) Pub. Date: Feb. 18, 2010

(54) SYSTEM AND METHOD FOR AUTHORIZING ACCESS TO A UMA NETWORK BASED ON ACCESS POINT IDENTIFIER

(76) Inventors: Janne P. Linkola, Espoo (FI); Christopher E. Caldwell, Woodstock, GA (US)

Correspondence Address: PERKINS COIE LLP;PATENT-SEA, P.O. BOX 1247, SEATTLE, WA, 98111-1247, US

(21) Appl. No.: 12/430,041

(22) Filed: Apr. 24, 2009

Related U.S. Application Data
(63) Continuation of application No. 11/435,504, filed on May 17, 2006, now abandoned.

(51) Int. Cl. H04M 1/66; H04W 60/00

(52) U.S. Cl. 455/411; 455/435.1

(57) ABSTRACT

A system and method are arranged to evaluate registration requests associated with a mobile subscriber (MS) in a fixed-mobile converged network. The fixed-mobile converged network consists of at least one fixed network topology (e.g., IP) and at least one mobile network topology (e.g., CDMA, TDMA, GSM, etc.). Registration request are received by the system from the MS. The registration request includes information identifying an access point (AP) where the MS obtained access to the fixed network. The identifying information is used to query a database to determine if the MS is authorized for access through the AP. The database can identify the AP in any number of ways, including but not limited to MAC address, IP address, and FQDN. The results form the database query are evaluated and the requested registration from the MS is either completed or rejected based on the access authorization associated with the AP.

### BACKGROUND

3GGP, or the 3rd Generation Partnership Project, is a collaboration agreement that was established in December 1998 between various organizations including: ETSI (Europe), ARIB/TTC (Japan), CCSA (China), ATIS (North America) and TTA (South Korea). The scope of 3GPP was to make a globally applicable third generation (3G) mobile phone system specification. Global System for Mobile Communications (GSM) is the most popular standard for mobile phones in the world. The 3GPP specifications are based on the evolution of the GSM specifications, now generally known as the UMTS (Universal Mobile Telecommunications System).

Unlicensed Mobile Access (UMA) lets wireless service providers merge cellular networks and wireless IP based networks (e.g., WLANs) into one seamless service with one mobile device, one user interface, and a common set of network services for both voice and data. The UMA solution can converge cellular networks with any IP-based wireless access network, such as IEEE 802.16 (WiMAX) networks, IEEE 802.20 Mobile Broadband Wireless Access (MBWA), Ultra Wideband (UWB) networks, 802.11 Wi-Fi networks, and Bluetooth networks. UMA has recently been accepted into release 6 of the 3GPP standard as a General Access Network (GAN).

With UMA or GAN, subscribers may move between the cellular networks and IP based networks with seamless voice and data session continuity as transparently as they move between cells within the cellular network. Seamless in-call handover between the WLAN and cellular network ensures that the user's location and mobility do not affect the services delivered to the user. The subscriber experiences service, location, and mobility transparency. Services may be identical when connected over the WLAN or the cellular network.

UMA effectively creates a parallel radio access network, the UMA network (UMAN), which interfaces to the mobile core network using existing mobility-enabled, standard interfaces. The mobile core network remains unchanged. The common mobile core network makes it possible to deliver full service, and operational transparency. The existing service provider Business Support Systems, service delivery systems, content services, regulatory compliance systems, and Operation Support Systems (OSS) can support the UMA network without change. Service enhancements and technology evolution of the mobile core network apply transparently to both the cellular access and UMA networks.

### BRIEF DESCRIPTION OF THE DRAWINGS

FIGS. 1A and 1B illustrate example systems that combine a cellular telephone network with a UMA network.

FIG. 2 is an illustration of a UNC that is configured in a UMA network for authorization and rejection of access based on AP identifiers.

FIG. 3 is an illustration of an example registration and authentication process flow.

FIG. 4 is an illustration of a logic flow for a UNC that is arranged to evaluate registration requests based on AP identifiers.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Briefly stated, a system and method are arranged to evaluate registration requests associated with a mobile subscriber (MS) in a fixed-mobile converged network. The fixed-mobile converged network consists of at least one fixed network topology (e.g., IP) and at least one mobile network topology (e.g., CDMA, TDMA, GSM, etc.). An example fixed-mobile converged network includes the combination of a cellular telephone network with a UMA network. Registration requests are received by the system from the MS. The registration request includes information identifying an access point (AP) where the MS obtained access to the fixed network. The identifying information is used to query a database to determine if the MS is authorized for access through the AP. The database can identify the AP in any number of ways, including but not limited to MAC address, IP address, and FQDN. The results from the database query are evaluated and the requested registration from the MS is either completed or rejected based on the access authorization associated with the AP.

UMA allows cellular service providers to offer their products and services seamlessly over Internet-connected broadband networks. Cellular phones may use Wi-Fi (802.11) wireless connections to access points that are then connected to DSL (Digital Subscriber Line) or cable modems, or some other broadband Internet connections such as in a subscriber's home or access points in public or corporate areas that have Internet connectivity.

The point of UMA is one of abstraction. A cellular service provider's systems that deliver content and handle mobility may not be aware that a subscriber's phone is on a UMA network. The system may instead assume the phone is on a GSM network just like any other.

A non-exhaustive list of products and services available on UMA includes not only voice services, but also supplementary services like call forwarding and call waiting, text messaging services like SMS, and data based services like ring-tone downloads, game downloads, picture messaging, email, and web browsing.

Instead of using towers broadcasting on licensed spectrum, UMA takes the familiar GSM system protocol, encapsulates it into Internet protocol packets and uses the Internet as a transport to deliver those to the cellular service provider's mobile core network bypassing the existing network of radio towers. Because GSM protocols are used both in the traditional radio tower and the IP network, the cellular service provider maintains a large degree of system compatibility while using the Internet to provide its services.

The following description applies to the use of cellular telephones and other wireless devices in a fixed-mobile converged network. The fixed-mobile converged network consists of at least one fixed network topology and at least one mobile network topology. An example fixed network topology is an Internet Protocol (IP) network topology. An example mobile network topology is a Cellular Telephone based network topology (e.g., CDMA, TDMA, GSM, etc.). The UMA Network that is described below is provided as one example IP network topology. In light of the present disclosure, one of skill will understand that the converged network has benefits in a variety of converged networks that include but are not limited to UMA Networks.

### Example UMA Network

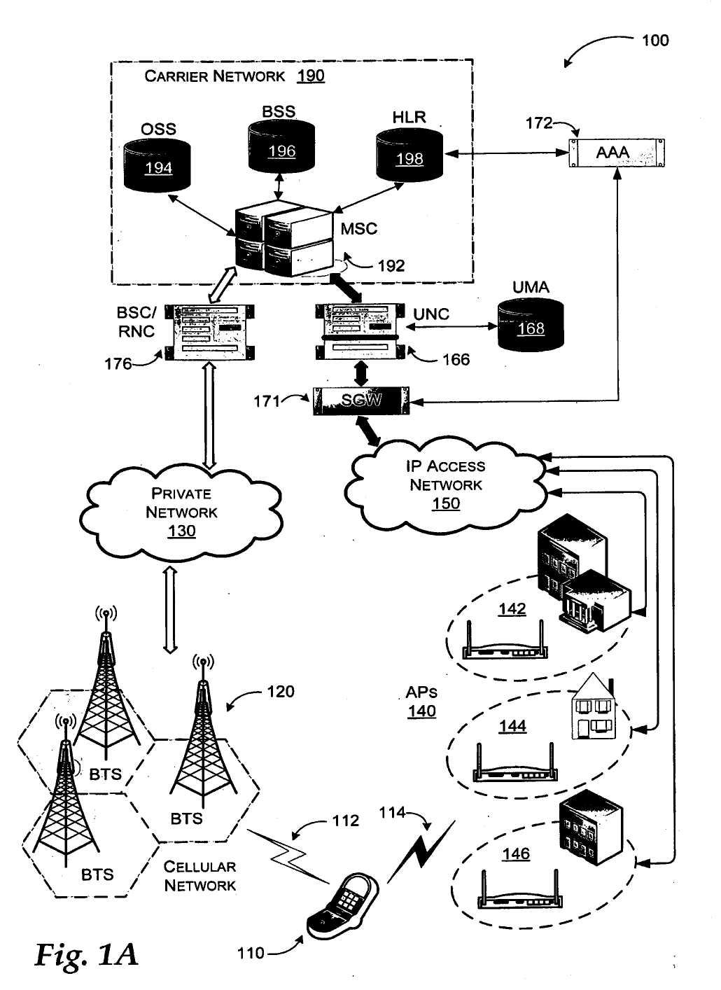

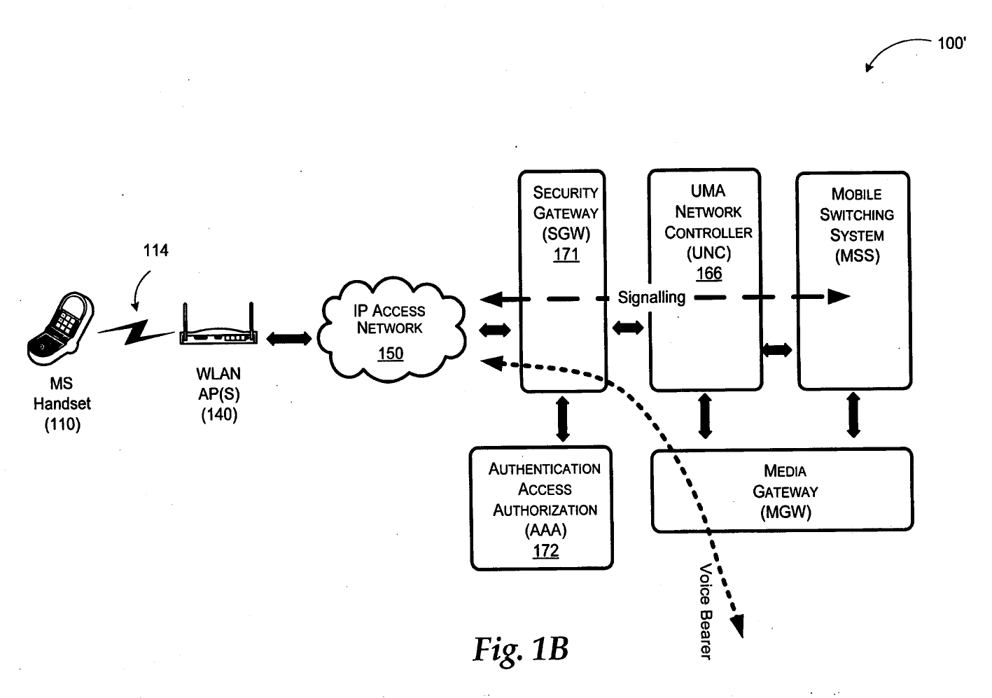

FIG. 1A is an illustration of a system that combines a cellular telephone network with a UMA network. The described system (100) is arranged to accept registration requests and call connections from a mobile subscriber (MS) handset (110) to either a cellular telephone network, or to a UMA network.

The example cellular telephone network includes one or more base transceiver stations (BTS 120) that are configured to accept cellular communications (112) from MS handset 110. The private network can include a variety of private connections such as T1 lines, a wide area network (WAN), a local area network (LAN), various network switches, to name a few. BSC/RNC 176 controls network communication traffic to the Carrier Network (190), where all communications are managed. An example Carrier Network (190) includes a mobile switching center (MSC 192), which is arranged as part of the core network for the carrier to control data/call flows, perform load balancing, as well as other functions. A variety of databases are also accessed in the Carrier Network such as (e.g., OSS 194, BSS 196, and HLR 198), for billing, call logging, etc.

The example UMA network includes an access point (AP 140) or multiple access points that are arranged to accept IP communications (114) from MS handset 110. AP 140 can be configured as part of a wireless network in one or more locations such as a public network (142), a home network (144), or a private business network (146). Each access point (AP) is coupled to an Internet protocol (IP) network (150) through a broadband connection. Many access points in a home setting also include IP routing capabilities. IP Network 150 is arranged to route IP packets that carry UMA calls (data, voice, SMS, etc.) between the APs and the security gateway (SGW 171). The security gateway controls access to the UMA network controller (UNC 166), which is arranged to communicate with a UMA database (UMA dB 168) for logging and accessing various data associated with UMA calls. UNC 166 is also arranged to communicate with the Carrier Network (190) similar to the BSC/RNC.

Authentication is handled by the security gateway (SGW 171), which is arranged to communicate with an authentication and access authorization (AAA) module (172) as shown in FIG. 1A. Challenges and responses to requests for access by an MS handset (110) are communicated between HLR database 198 and the AAA module 172. When authorization is granted, SGW 171 is arranged to communicate the assignment of a GAN IP address to MS handset 110. Once the GAN IP address is passed to MS handset 110 by SGW 171, the public IP address assigned to the handset is passed to the UNC.

FIG. 1B illustrates another example system that combines a cellular telephone network (or Carrier/Mobile Network) with a UMA network. The described system (100′) is again arranged to accept registration requests and call connections from a mobile subscriber (MS) handset (110) to either a cellular telephone network (not shown), or to a UMA network.

The example UMA network includes one or more access points (AP 140) that are arranged to accept UMA communications (114) from MS handset 110 via an IP connection. Each access point (AP) is again coupled to an Internet protocol (IP) network (150) through a broadband connection. IP Network 150 is arranged to route UMA calls (data, voice, SMS, etc.) between the APs and a security gateway (SGW 171). The security gateway (SGW 171) controls access to the UMA network controller (UNC 166), which is arranged to communicate with a UMA database (not shown) for logging and accessing various data associated with UMA calls. SGW 171 via AAA module 172, as previously described, handles authentication, access, and authorization.

For example system 100′, the signaling path is routed through UNC 166 to a mobile switching system (MSS), while the voice bearer path is routed through UNC 166 to a media gateway (MGW). The signaling portion of a UMA call governs various overhead aspects of the UMA call such as, for example, when the call starts, when the call stops, initiating a telephone ring, etc. The voice bearer portion of the UMA call contains the actual content of the UMA call itself (which can contain either data or voice information). The MGW controls the content flow between the service provider and the UMA MS handset (110), while the MSS controls the signaling flow (or control overhead related flow) between the service provider and the UMA MS handset (110).

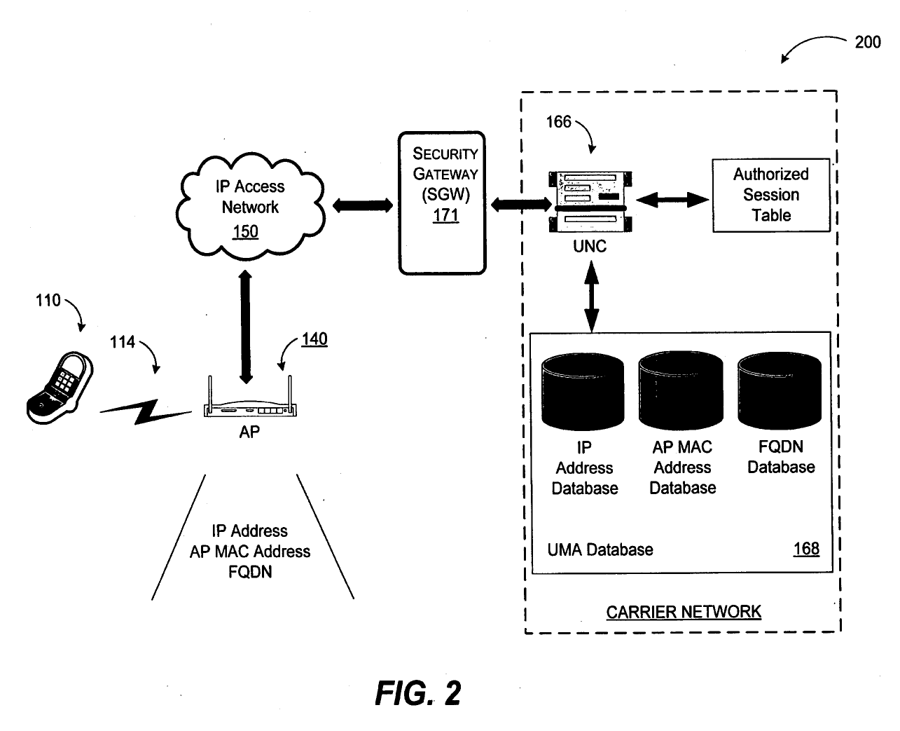

FIG. 2 is an illustration of a UNC that is configured in a UMA network for managing network authorization. A mobile subscriber (MS) handset (110) is arranged to initiate a connection request with a UMA network via a wireless connection (114) to a local area network (LAN) access point (AP 140). LAN AP 140 is arranged to communicate with a UMA network controller (UNC 166) via an IP access network (150), and a security gateway (SGW 171). UNC 166 is arranged to monitor connection requests associated with each MS, process each connection request, and either permit or reject access to the UMA network based on at least one identifiers associated with the MS. UNC 166 can maintain authorized accesses to the UMA network with an authorized session table, or similar data construct. UNC 166 is arranged in communication with a database (UMA dB 168) to determine if the MS is authorized for access to the UMA network. Example connection information may include a media access control (MAC) address associated with an access point, an International Mobile Subscriber Identifier (IMSI) associated with mobile subscriber handset, and an Internet protocol (IP) address (or “Public IP address”) associated with the access point, a fully qualified domain name (FQDN), to name a few. UMA dB 168 may be a combination of databases such as one for IP addresses, one of MAC addresses, and one for FQDN, or a single database that includes all such identifiers. The databases may be arranged to include “blocked” identifiers such as may be referred to as “blacklisted”, as well as “authorized” identifiers that may be referred to as “whitelisted.”

### UMA Network Access Identifiers

Because the networks associated with UMA calls are potentially shared among many different broadband services, with varying points of access, it is important for the UMA network to understand the point of entry into the network. In a simple example system, a single user with a static identifier (e.g., a static IP address) accesses the UMA network from a single point of entry. In other example systems, UMA devices (e.g., a handset) are used on private networks that host a number of devices such as computers, PDAs, other UMA phones, and other devices. These private networks share a single Internet connection. To the UMA network, all UMA usage from a shared point of entry appears to be from a single identifier (e.g. a single IP address).

An IP address is included in the unique identifier for the local radio network that is reported by the UMA MS when registering to the UMA network. In the case of a wireless access points (e.g., a Wi-Fi access point under 802.11a/b/g/n), the unique identifier is the MAC address of the access point (AP). The MAC address (or Media Access Control address) is a twelve (12) character hexadecimal value that is assigned to networking equipment including Wi-Fi access points (APs). Typical the first characters in the MAC address signify the manufacturer of the networking equipment. The latter characters are serialized to make the MAC unique.

According to one aspect of the present disclosure, the UMA network is configured to monitor the registration process to authorize or reject registration requests for each mobile subscriber (MS) according to their IP address. According to another aspect of the present disclosure, the UMA network is configured to monitor the registration process to authorize or reject connections for each mobile subscriber (MS) according to the MAC address of the access point (AP). According to still another aspect of the present disclosure, the UMA network is configured to monitor the registration process to authorize or reject connections for each mobile subscriber (MS) according to the fully qualified domain name (FQDN) associated with the MS.

A subscriber or mobile subscriber (MS) may attempt to use a UMA device from any global location that has available Internet access. In some situations, it may be desirable to reject connections from any UMA device that is located in a specific geographic location. In one example, a specific access point may be underperforming such that there would be a very poor user experience for UMA calls from that specific access point. In another example, a specific access point may be located in a geographic region where the service provider does not offer UMA call services. In still another example, an access point may be prone to fraud related issues for some reason. For any of the above-described reasons, as well as others, a blacklisting of the access point can be made to specifically reject any of the unauthorized access pints. The IP address, MAC address, and/or FQDN of these blacklisted locations can be identified in the UMA dB. Similarly, the IP address, MAC address, and/or FQDN of fully authorized networking devices can be whitelisted in the UMA dB.

### Registration and Authentication Process Flow

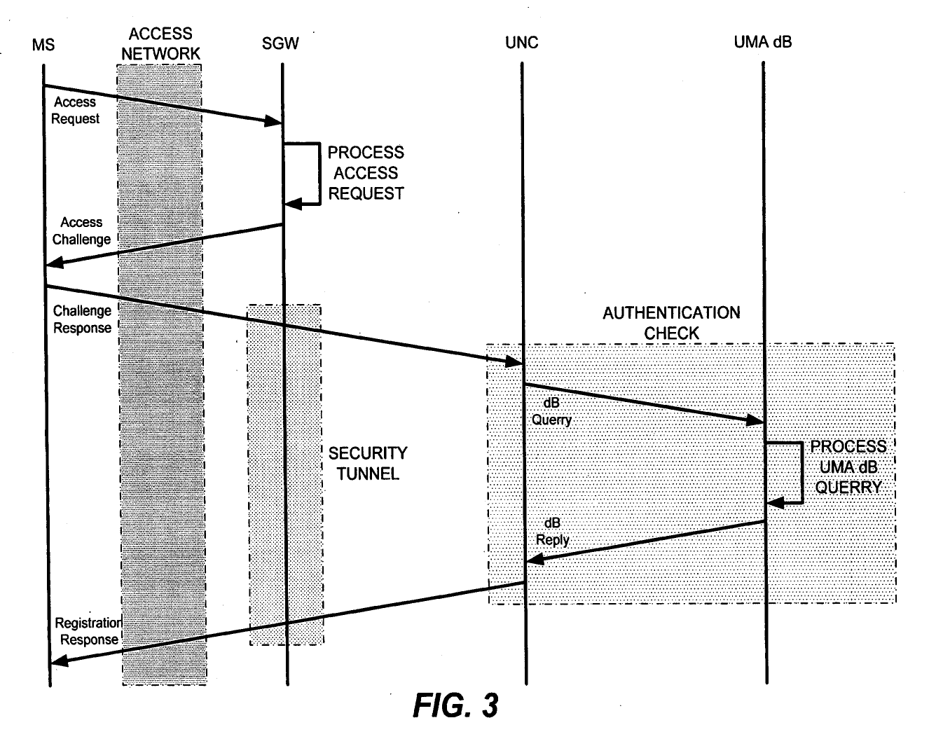

A mobile subscriber (MS) cannot generally access network services until after the MS device is registered in the UMA network. An example registration and authentication process flow is illustrated in FIG. 3.

The MS initially attempts to connect to the UMA network by sending an access request message to the security gateway (SGW) through the access network. The SGW receives the request for access, and communicates information about the MS to the AAA module for evaluation by the access database (e.g., HLR from FIG. 1A). The access database provides information to the SGW via the AAA module, such that the SGW can present a challenge to the MS. The MS communicates a challenge response back to the SGW through the access network. After the SGW evaluates the challenge, either access is granted to the MS or denied. Upon the granting of access, the SGW will communicate the assignment of an IP address to the MS.

The MS challenge response described above includes identifiers associated with an access point, such as the MAC address of the AP, the Public IP address of the AP, and/or the FQDN of the AP. The UNC receives the identifier(s) for the AP from the SGW, based upon the challenge response from the MS. The UNC then processes the identifier(s) to determine if the identified AP is permitted access to the UMA network. The UNC sends a query to the UMA database (dB) to determine if the AP is authorized. The UMA dB processes the UMA dB query, determines if the identified AP is authorized (e.g., whitelisted, blacklisted, etc.), and communicates a reply that indicates the status of the authorization as granted or rejected. The UNC completes the authentication check based on the dB reply and communicates a response back to the MS via the security tunnel that the requested registration is either granted or rejected.

### Example Process Flow

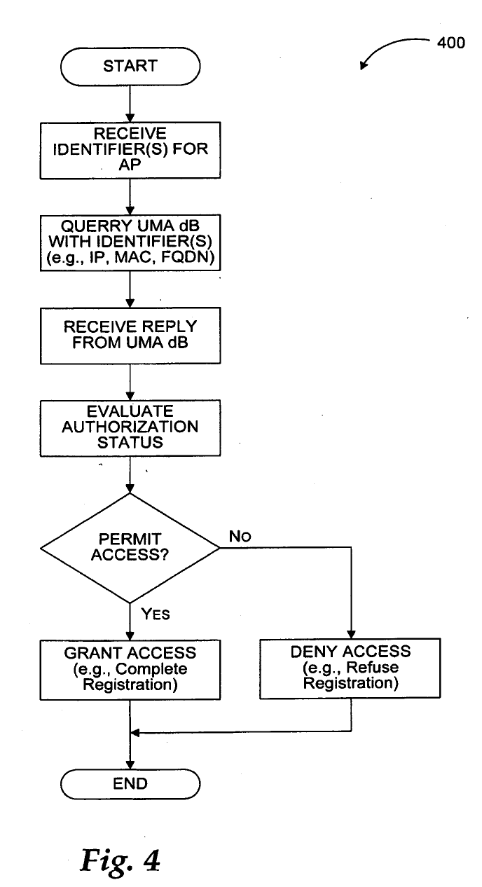

FIG. 4 illustrates a logic flow diagram for a UNC that is arranged to evaluate registration requests according to an aspect of the present disclosure. Processing begins when the UNC receives a registration request from a MS, where the registration request includes identifiers associated with an AP. The UNC communicates a query to the UMA dB that includes the one or more identifiers associated with the registration of the MS through the particular AP. The UMA dB processes the UMA dB query, determines if the registration of the MS through the identified AP is authorized (e.g., whitelisted, blacklisted, etc.), and communicates a reply to the UNC that indicates the status of the authorization as granted or rejected. The UNC receives the reply from the UMA dB, evaluates the reply, and communicates a response back to the MS via the security tunnel that the requested registration is either granted or rejected.

The described UMA dB can include a number of keyed database entries including any one of: the “Public” IP address of each AP (which in a technical sense can merely be a router, or a wireless AP that works in conjunction with a router), the MAC address of each AP, and the FQDN associated with an AP. The IP addresses for an AP may be a single IP address, a list of IP addresses, or a range of IP addresses. The FQDN for an AP may be a single FQDN, or a list of FQDNs. Additionally, the UMA dB can include: the SSID associated with an AP, the serving UNC for each AP, the assumed country code for each AP, the time zone associated with each AP, date and time associated with last known access by each AP, the full address (e.g., street, city, state, etc.) of each AP, the latitude and longitude associated with each AP, and a status the database entry as blacklisted, whitelisted, or otherwise, and any other appropriate details associated with the APs.

In an example where blacklisting is used, the MAC address of the AP is compared against the blacklisted AP MAC addresses in the UMA database. For this example the AP is refused access when the MAC addresses is listed in the UMA dB, and the AP is granted access when the MAC address is not found in the UMA dB.

In an example where whitelisting is used, the MAC address of the AP is compared against the blacklisted AP MAC addresses in the UMA database. For this example the AP is granted when the MAC addresses is listed in the UMA dB, and the AP is refused access when the MAC address is not found in the UMA dB.

The present disclosure is not limited to the above-described environment. Many other configurations of computing devices, communications, applications, and distribution systems may be employed to implement a system for monitoring UMA call quality metrics based on the IP address and the AP to ensure acceptable quality for UMA calls.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for evaluating registration requests associated with a mobile subscriber (MS) in a fixed-mobile converged network, wherein the fixed-mobile converged network includes an Internet Protocol Network and a Carrier Network, the computer-implemented method comprising:
receiving a registration request from the MS, wherein the registration request is associated with a request to register the MS with the Internet Protocol Network;
identifying an access point (AP) that is associated with the registration request;
querying a database (dB) with at least one identifier associated with the AP session, wherein the dB includes entries associated with identifiers for APs;
receiving a reply from the dB;
evaluating the reply to determine an authorization status for the registration request, wherein the determined authorization status corresponds to at least one of access permitted and access denied;
rejecting the registration request when the determined authorization status corresponds to deny access; and
completing the registration request when the determined authorization status corresponds to grant access.

2. The computer-implemented method of claim 1, wherein the at least one identifier corresponds to at least one of: a Media Access Control (MAC) address that is assigned to the AP, an Internet Protocol (IP) address that is assigned to the AP, a fully-qualified domain name (FQDN) that is assigned to the AP, the Media Access Control (MAC) address that is assigned to a router that is serving the AP, an IP address that is assigned to the router that is serving the AP, and a fully-qualified domain name (FQDN) that is assigned to the router that is serving the AP.

3. The computer-implemented method of claim 2, wherein the entries in the dB correspond to at least one of: a MAC address, a range of MAC addresses, a list of MAC addresses, an IP address, a range of IP addresses, a list of IP addresses, a FQDN, and a list of FQDNs.

4. The computer-implemented method of claim 1, further comprising: comparing the at least one identifier associated with the AP to entries in the dB in response to the query, and identifying an authorization status as deny access when the at least one identifier is found in an entry of the dB.

5. The computer-implemented method of claim 1, further comprising: comparing the at least one identifier associated with the AP to entries in the dB in response to the query, and identifying an authorization status as grant access when at least one identifier is found in an entry of the dB.

6. The computer-implemented method of claim 1, wherein the entries associated with the dB correspond to at least one of: a blacklist, a whitelist, an authorization access list, and an authorization rejection list.

7. A system for evaluating registration requests associated with a mobile subscriber (MS) in a in a fixed-mobile converged network, wherein the fixed-mobile converged network includes a UMA Network and a Carrier Network, the method comprising:
an access point (AP) that is arranged to coordinate communication between the MS and the UMA Network;
a security gateway (SGW) that is arranged to: communicate with the MS via the AP, receive a registration request from the MS, and communicate a registration challenge to the MS, wherein the registration request is associated with a request to register with the UMA Network;
a UMA database (dB) that is indexed according to at least one identifier associated with at least one AP; and
a UMA controller (UNC) that is arranged in communication with the UMA dB and the SGW, wherein the UNC is arranged to:
evaluate the registration request;
retrieve an identifier associated with the AP associated with the registration request;
query the UMA dB with the retrieved identifier;
receive a reply from the UMA dB;
evaluate the reply from the UMA dB for an authorization status, and
reject the registration request when the determined authorization status corresponds to deny access; and
grant the registration request when the determined authorization status corresponds to grant access.

8. The system of claim 7, wherein the identifier corresponds to at least one of: a Media Access Control (MAC) address that is assigned to the AP, an Internet Protocol (IP) address that is assigned to the AP, a fully-qualified domain name (FQDN) that is assigned to the AP, the Media Access Control (MAC) address that is assigned to a router that is serving the AP, an IP address that is assigned to the router that is serving the AP, and a fully-qualified domain name (FQDN) that is assigned to the router that is serving the AP.

9. The system of claim 8, wherein entries in the UMA dB correspond to at least one of: a MAC address, a range of MAC addresses, a list of MAC addresses, an IP address, a range of IP addresses, a list of IP addresses, a FQDN, and a list of FQDNs.

10. The system of claim 7, the UMA dB further comprising: a means for comparing the identifier associated with the AP to entries in the UMA dB in response to the query, and a means for identifying an authorization status as deny access when the at least one identifier is found in an entry of the UMA dB.

11. The system of claim 7, the UMA dB further comprising: a means for comparing the identifier associated with the AP to entries in the UMA dB in response to the query, and a means for identifying an authorization status as grant access when the at least one identifier is found in an entry of the UMA dB.

12. The system of claim 7, wherein the entries associated with the UMA dB correspond to at least one of: a blacklist, a whitelist, an authorization access list, and an authorization rejection list.

13. An Unlicensed Mobile Access Network Controller (UNC) for managing access authorization between a mobile subscriber (MS) and an Unlicensed Mobile Access (UMA) Network, the UNC comprising:
a means for monitoring registration requests associated with a mobile subscriber (MS) that is managed in the UMA Network;
a means for identifying an access point that is associated with the call connection of the MS to the UMA network, wherein the access point is identified by at least one of a Media Access Control (MAC) address, an Internet Protocol (IP) address, an a fully qualified domain name (FQDN);
a means for retrieving an authorization status associated with the identified AP from a UMA database (dB), wherein the authorization status corresponds to one of: access granted, and access denied; and
a means for rejecting the registration request from the MS when the retrieved authorization status corresponds to access denied.
a means for accepting the registration request from the MS when the retrieved authorization status corresponds to access granted.

14. The UNC of claim 13, further comprising: a means for querying the UMA dB with the identified associated with the AP, and a means for receiving a reply from the UMA dB, wherein the reply from the UMA dB includes the authorization status associated with the AP.

15. The UNC of claim 13, wherein entries in the UMA dB correspond to at least one of: a MAC address, a range of MAC addresses, a list of MAC addresses, an IP address, a range of IP addresses, a list of IP addresses, a FQDN, and a list of FQDNs.

16. The system of claim 7, further comprising: a means for identifying the AP on at least one of: a blacklist, a whitelist, an access authorization list, and an access rejection list.

17. The system of claim 7, further comprising at least one of: a means for adding another identifier to a blacklist in the UMA dB, a means for removing the other identifier from the blacklist in the UMA dB, a means for adding the other identifier to a whitelist in the UMA dB, a means for removing the other identifier from the whitelist in the UMA dB, wherein the other identifier is associated with another AP.
